(19) United States
(12) Patent Application Publication
(10) Pub. No.: US 2009/0236302 A1
(43) Pub. Date: Sep. 24, 2009

(54) Finish Portion For Plastic Preform and Container and Method of Making

(75) Inventors: Joseph P. Labadie, Perrysburg, OH (US); Richard R. Johnston, Toledo, OH (US); Lance J. Novotny, Gibsonburg, OH (US)

Correspondence Address: KNOBLE, YOSHIDA & DUNLEAVY, EIGHT PENN CENTER, SUITE 1350, 1628 JOHN F KENNEDY BLVD, PHILADELPHIA, PA, 19103, US

(73) Assignee: GRAHAM PACKAGING COMPANY, L.P., York, PA (US)

(21) Appl. No.: 12/050,358

(22) Filed: Mar. 18, 2008

(51) Int. Cl. B29C 49/00; B29B 11/06; B65B 7/28

(52) U.S. Cl. 215/44; 428/542.8; 215/384; 264/259

(57) ABSTRACT

A preform for making a plastic container includes a main body portion and a threaded finish portion that has an outer surface and an inner surface. The threaded finish portion has a proximal and that is unitary with the main body portion of the preform and a distal end that is opposite from the proximal end. At least one external thread is defined on the outer surface of the finish portion. A gripping indentation is advantageously defined in the outer surface and is longitudinally positioned between the external thread and the distal end of the finish portion. A container having such a finish portion and a method of making a container is also disclosed.

### BACKGROUND OF THE INVENTION

1. Field of the Invention

This invention relates generally to the field of packaging, and more specifically to preforms for making plastic containers, plastic containers and methods for making such plastic containers.

2. Description of the Related Technology

It is well known to manufacture plastic containers by injection molding preforms of plastic, such as PET, and blow-molding the preforms in a mold cavity using a stretch blow molding process. After molding, the resulting preforms are discharged from the mold and are typically packaged for shipment to another location for filling with a consumer product such as a beverage. After filling, the containers are capped, boxed and palletized for distribution to the ultimate consumer.

At the blow molding location, preforms are customarily fed in single file to a feeding mechanism which transfers the preforms to a conveyor which spaces them from one another and advances them in an open loop path through a pre-heat oven. In order to facilitate handling by such transfer mechanisms, the preforms are typically molded so as to have one or more transfer beads or recesses that may be gripped by the transfer mechanism. One type of transfer mechanism uses chain-type conveyors in the pre-heat oven to engage the preforms at their neck finishes while they are being heated. Sidel of Le Havre France, manufactures a rotary preform transfer device which grips the preheated preforms about their necks and transfers them into the blow mold. The device rotates much like a star-wheel, about a vertical axis, but has claw-like gripping elements which grip the preform about its neck finish and advance it in an arcuate path to a like gripper associated with the blow mold. The gripper on the rotary transfer device is designed to release the preform only after the blow-mold gripper has actually gripped the preform. As a result, the preform is always under positive control as it transits through the pre-heat oven and the blow-mold apparatus

The preforms are conveyed by the transfer mechanism to a preheating oven and are heated to a predetermined temperature by various means, such as radiant heaters. After the preforms are heated to the desired temperature, usually near the glass transition temperature (Tg) of the particular plastic from which the preform is molded, the preform is transferred into a blow-mold cavity. In what is known as the stretch blow molding process, the preform is forcibly expanded by means of compressed air into the shape of the mold cavity while simultaneously being subjected to axial stretching in order to effect biaxial orientation of the container. After a brief residence period in the mold, the resulting blown container is discharged from the mold for and is shipped or conveyed to another location for filling.

Unfortunately, certain types of preforms may have a shape that is incompatible with common transfer mechanisms, making it difficult or impossible for the transfer mechanism to reliably grip the purchasing structure of the preform and convey the preform to its intended destination. In addition, aesthetic concerns may limit placement of purchasing structure on the preform.

### SUMMARY OF THE INVENTION

Accordingly, it is an object of the invention to provide a preform, container and method of making a container that optimize gripping of the preform by a transfer mechanism and that provides a container assembly that is aesthetically attractive.

In order to achieve the above and other objects of the invention, a plastic preform according to one aspect of the invention may include a main body portion; and a threaded finish portion, the threaded finish portion having an outer surface and an inner surface, the threaded finish portion further comprising: a proximal end that is unitary with the main body portion; an opposite distal end; at least one thread defined on the outer surface; and a gripping indentation defined in the outer surface, the gripping indentation being longitudinally positioned between the thread and the opposite distal end.

According to a second aspect of the invention, a plastic container may include a main body portion; and a threaded finish portion, the threaded finish portion having an outer surface and an inner surface, the threaded finish portion further comprising: a proximal end that is unitary with the main body portion; an opposite distal end; at least one thread defined on the outer surface; and a gripping indentation defined in the outer surface, the gripping indentation being longitudinally positioned between the thread and the opposite distal end.

A method of making a plastic container according to a third aspect of the invention may include steps of providing a preform having a threaded finish portion that has at least one external thread and a gripping indentation that is located between the external thread and a distal end of the preform; engaging the preform with a transfer apparatus; and blow molding a container using the preform.

These and various other advantages and features of novelty that characterize the invention are pointed out with particularity in the claims annexed hereto and forming a part hereof. However, for a better understanding of the invention, its advantages, and the objects obtained by its use, reference should be made to the drawings which form a further part hereof, and to the accompanying descriptive matter, in which there is illustrated and described a preferred embodiment of the invention.

### BRIEF DESCRIPTION OF THE DRAWINGS

FIG. 1 is a fragmentary side elevational view showing a preform that is constructed according to a preferred embodiment of the invention;

FIG. 2 is a cross-sectional view taken along lines 2-2 in FIG. 1;

FIG. 3 is a fragmentary side elevational view showing a container that is constructed according to a preferred embodiment of the invention;

FIG. 4 is a cross-sectional view taken along lines 4-4 in FIG. 1; and

FIG. 5 is a flowchart depicting a method that is performed according to a preferred embodiment of the invention.

### DETAILED DESCRIPTION OF THE PREFERRED EMBODIMENT(S)

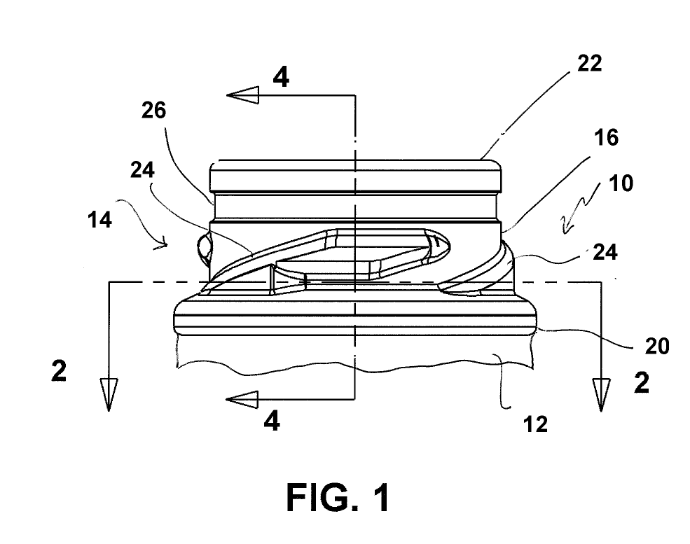

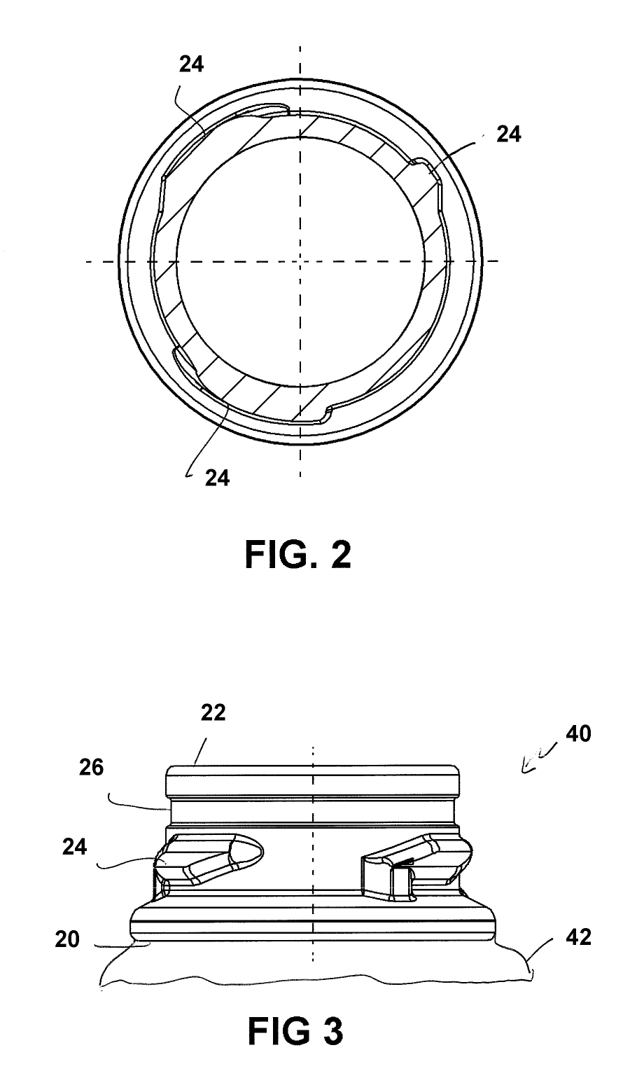

Referring now to the drawings, wherein like reference numerals designate corresponding structure throughout the views, and referring in particular to FIG. 1, a plastic preform 10 that is constructed according to a preferred embodiment of the invention is preferably fabricated from a plastic material, most preferably polyethylene terephthalate or PET. Plastic preform 10 includes a main body portion 12 and a threaded finish portion 14 that has an outer surface 16 and an inner surface 18, which is best shown in FIG. 4.

As is best shown in FIGS. 1 and 4, plastic preform 10 is constructed so as to further include a proximal end 20 that is unitary with the main body portion 12 and an opposite, distal end 22 that preferably includes a sealing surface to seal against an inside of a closure in conventional fashion.

At least one thread 24 is preferably defined on the outer surface 16 of the threaded finish portion 14. In the illustrated embodiment, the threaded finish portion 14 is provided with a plurality of a external threads 24, which are of the type that are configured to meet with a conventional metallic lug type closure. However, any conventional type of external threading could be used within the scope of the invention. For example, continuous helical threads could be provided, or helical threads having interruptions defined therein for venting purposes could be used.

At least one gripping indentation 26 is preferably defined in the outer surface 16 of the threaded finish portion 14 in a location that is longitudinally positioned between the thread 24 and the opposite, distal end 22 of the threaded finish portion 14. In the preferred embodiment, there is one such gripping indentation 26 defined in the outer surface 16. It preferably has an annular shape and it preferably extends about an entire circumference of the outer surface 16 of the threaded finish portion 14.

As is schematically depicted in FIG. 4, gripping indentation 26 preferably has a depth DG that is within a range of about 0.015 inches to about 0.040 inches. Gripping indentation 26 preferably includes a substantially flat lower surface 28, a first side wall 30 that is located on a distal end of the substantially flat lower surface 28 and a second side wall 32 that is located on a proximal end of the substantially flat lower surface 28.

The substantially flat lower surface 28 preferably has a longitudinal dimension L_{G} that is within a range of about 0.085 inches to about 0.125 inches.

The first side wall 30 preferably is shaped to have a uniform longitudinal cross-section about an entire rotation of the threaded finish portion 14, and preferably forms an angle α₁ with respect to a plane that is perpendicular to the substantially flat lower surface 28 that is within a range of about 0° to about 20°.

The second side wall 32 is shaped so it that it also has a uniform longitudinal cross-section about an entire rotation of the threaded finish portion 14, and preferably forms an angle α₂ with respect to a plane that is perpendicular to the substantially flat lower surface 28 that is within a range of about 0° to about 80°.

A longitudinal dimension L_{d} between the gripping indentation 26 and the distal end 22 of the threaded finish portion 14 is preferably within a range of about 0.04 inches to about 0.25 inches.

The flat portion 28 of the gripping indentation 26 preferably is substantially cylindrical in shape and defines an internal radius R_{G} that is within a range of about 0.75 inches to about 1.25 inches.

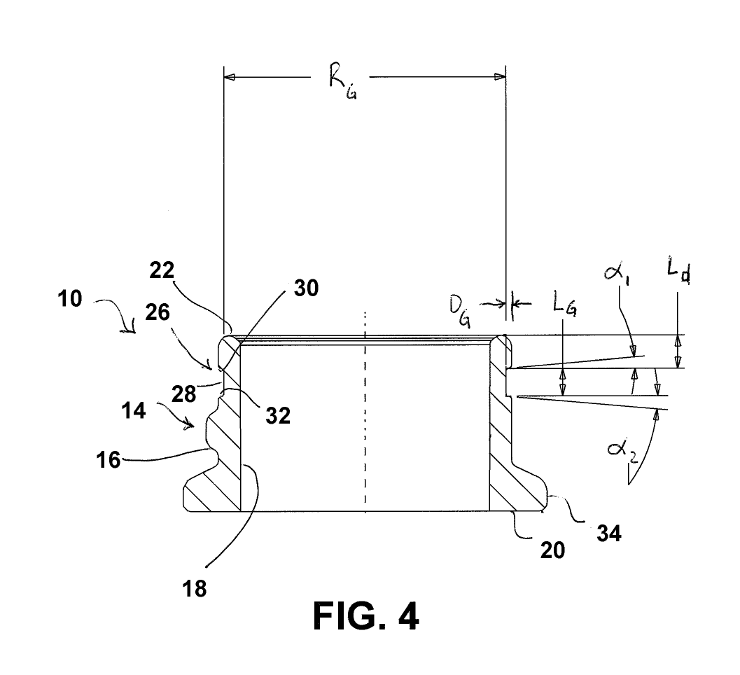

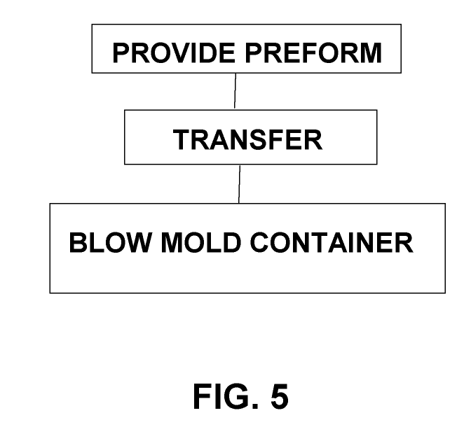

A method that is performed according to a preferred embodiment of the invention is schematically depicted in FIG. 5. A preform corresponding to that described above is first provided, and then is engaged with a transfer apparatus that engages the preform at the gripping indentation. Preferably, the preform is engaged so that the flat portion 28 of the gripping indentation 26 is contacted. The transfer apparatus conveys the preform to a blow molding station where it is blow molded into a container 40, which is shown in FIG. 3.

The container 40 includes a main body portion 42 and a threaded finish portion that is substantially identical to the threaded finish portion described above with reference to the plastic preform 10.

It is to be understood, however, that even though numerous characteristics and advantages of the present invention have been set forth in the foregoing description, together with details of the structure and function of the invention, the disclosure is illustrative only, and changes may be made in detail, especially in matters of shape, size and arrangement of parts within the principles of the invention to the full extent indicated by the broad general meaning of the terms in which the appended claims are expressed.

What is claimed is:

1. A plastic preform, comprising:
a main body portion; and
a threaded finish portion, said threaded finish portion having an outer surface and an inner surface, said threaded finish portion further comprising:
a proximal end that is unitary with said main body portion;
an opposite distal end;
at least one thread defined on said outer surface; and
a gripping indentation defined in said outer surface, said gripping indentation being longitudinally positioned between said thread and said opposite distal end.

2. A plastic preform according to claim 1, wherein said gripping indentation has an annular shape.

3. A plastic preform according to claim 1, wherein said gripping indentation extends about a circumference of said outer surface of said threaded finish portion.

4. A plastic preform according to claim 1, wherein said gripping indentation has a depth that is within a range of about 0.015 inches to about 0.040 inches.

5. A plastic preform according to claim 2, wherein said annular gripping indentation comprises a substantially flat lower surface.

6. A plastic preform according to claim 5, wherein said annular gripping indentation comprises a first side wall that is located on a distal end of said substantially flat lower surface, said first side wall forming an angle with respect to a plane that is perpendicular to said substantially flat lower surface that is within a range of about 0° to about 20°.

7. A plastic preform according to claim 5, wherein said annular gripping indentation comprises a second side wall that is located on a proximal end of said substantially flat lower surface, said second side wall forming an angle with respect to a plane that is perpendicular to said substantially flat lower surface that is within a range of about 0° to about 80°.

8. A plastic preform according to claim 5, wherein said substantially flat lower surface has a longitudinal dimension that is within a range of about 0.085 inches to about 0.125 inches.

9. A plastic preform according to claim 1, wherein a longitudinal dimension between said gripping indentation and said distal end of said threaded finish portion is within a range of about 0.04 inches to about 0.25 inches.

10. A container that is made using a plastic preform according to claim 1.

11. A plastic container, comprising:
a main body portion; and
a threaded finish portion, said threaded finish portion having an outer surface and an inner surface, said threaded finish portion further comprising:
a proximal end that is unitary with said main body portion;
an opposite distal end;
at least one thread defined on said outer surface; and
a gripping indentation defined in said outer surface, said gripping indentation being longitudinally positioned between said thread and said opposite distal end.

12. A plastic container according to claim 11, wherein said gripping indentation has an annular shape.

13. A plastic container according to claim 11, wherein said gripping indentation extends about a circumference of said outer surface of said threaded finish portion.

14. A plastic container according to claim 11, wherein said gripping indentation has a depth that is within a range of about 0.015 inches to about 0.040 inches.

15. A plastic container according to claim 12, wherein said annular gripping indentation comprises a substantially flat lower surface.

16. A plastic container according to claim 15, wherein said annular gripping indentation comprises a first side wall that is located on a distal end of said substantially flat lower surface, said first side wall forming an angle with respect to a plane that is perpendicular to said substantially flat lower surface that is within a range of about 0° to about 20°.

17. A plastic container according to claim 15, wherein said annular gripping indentation comprises a second side wall that is located on a proximal end of said substantially flat lower surface, said second side wall forming an angle with respect to a plane that is perpendicular to said substantially flat lower surface that is within a range of about 0° to about 80°.

18. A plastic container according to claim 15, wherein said substantially flat lower surface has a longitudinal dimension that is within a range of about 0.085 inches to about 0.125 inches.

19. A plastic container according to claim 11, wherein a longitudinal dimension between said gripping indentation and said distal end of said threaded finish portion is within a range of about 0.04 inches to about 0.25 inches.

20. A method of making a plastic container, comprising steps of:
providing a preform having a threaded finish portion that has at least one external thread and a gripping indentation that is located between the external thread and a distal end of the preform;
engaging the preform with a transfer apparatus; and
blow molding a container using the preform.
